(19) United States
(12) Patent Application Publication
(10) Pub. No.: US 2024/0271059 A1
(43) Pub. Date: Aug. 15, 2024

(54) System and Methods for Processing Fatty Acids

(71) Applicant: SABIC GLOBAL TECHNOLOGIES B.V., Bergen op Zoom (NL)

(72) Inventors: Vinodkumar Vasudevan, Riyadh (SA); Flaiyh Farhan N. Al-Anazi, Riyadh (SA); Jefrey Pagsisihan Anonuevo, Riyadh (SA)

(21) Appl. No.: 18/563,091

(22) PCT Filed: May 25, 2022
(86) PCT No.: PCT/IB2022/054928

§ 371 Date: Nov. 21, 2023

(30) Foreign Application Priority Data
May 25, 2021 (EP) 21175786.9

(51) Int. Cl. C11C 1/08; C11B 3/10

(52) U.S. Cl. CPC C11C 1/08; C11B 3/10

(57) ABSTRACT

Systems and methods for processing crude fatty acid stream that comprises short chain fatty acids and impurities are disclosed. The crude fatty acid stream is mixed with activated carbon or acidified activated carbon for a predetermined duration to produce a fatty acid product stream that comprises short chain fatty acids and an amount of impurities that is lower than the amount of impurities in the crude fatty acid stream.

### CROSS REFERENCE TO RELATED APPLICATIONS

This application claims the benefit of priority of European Patent Application No. 21175786.9, filed May 25, 2021, which is hereby incorporated by reference in its entirety.

### FIELD OF INVENTION

The present invention generally relates to systems and methods for processing fatty acids. More specifically, the present invention relates to systems and methods for processing short chain fatty acids to remove impurities therefrom.

### BACKGROUND OF THE INVENTION

Fatty acids are used in a wide variety of industries including pharmaceutical, food processing, and cosmetics. Generally, color stability of fatty acids is one of the main concerns for these applications. Due to un-saturation, high color impurities and low oxidative stability, the color value of the fatty acids tends to increase drastically during the processes of utilizing the fatty acids, resulting in the fatty acids being off-specification.

For fatty acids production, inexpensive starting materials, such as, natural oils, fats, and other fatty materials, are often utilized. These oils and/or fats are subjected to appropriate splitting conditions to release fatty acids. Examples of such splitting processes include hydrolysis by pressure splitting and enzymatic splitting. After the splitting step, the crude fatty acid product typically contains impurities including unsplit or incompletely split glycerides (like mono and diglycerides), color bodies, water, and/or compounds such as sterols and phosphatides.

Conventionally, the crude fatty acid product is first processed in a hydrogenation unit to saturate non-heat stable fatty acids, and the effluent from the hydrogenation unit is then separated to remove any impurity via distillation and produce a fatty acid product that meets the required specification. However, the conventional method consumes hydrogen, which is expensive, and the method also requires a large amount of energy for distillation. Thus, the overall cost for conventional method of purifying fatty acids is relatively high.

Overall, while the systems and methods for processing and purifying crude fatty acids exist, the need for improvements in this field persists in light of the aforementioned drawbacks with conventional methods.

### BRIEF SUMMARY OF THE INVENTION

A solution to the above-mentioned problems associated with the systems and methods for processing and purifying crude fatty acids has been discovered. The solution resides in a method of processing a crude fatty acid stream that comprises short chain fatty acids and impurities. The method includes mixing the crude fatty acid stream with an adsorbent for a predetermined duration to produce purified fatty acids with reduced impurities. The adsorbent adsorbs impurities in the crude fatty acid stream. Notably, the method is capable of reducing the processing steps needed for purifying fatty acids, resulting in less complex operations compared to conventional methods. Additionally, the disclosed method does not require hydrogenation, leading to reduced material cost (e.g., cost for hydrogen and/or catalyst). Furthermore, the disclosed method does not require distillation, resulting in reduced energy consumption and capital expenditure. Therefore, the disclosed method of the present invention provides a technical solution to the problem associated with the conventional systems and methods for processing and purifying crude fatty acids.

Embodiments of the invention include a method of processing a crude fatty acid stream comprising short chain fatty acids and impurities. The method comprises mixing the crude fatty acid stream with an adsorbent for a predetermined duration to produce a fatty acid product stream comprising short chain fatty acids and an amount of impurities that is less than the amount of impurities in the crude fatty acid stream. Preferably, the fatty acid product stream comprises C8 to C18 fatty acids, preferably C8 to C10 fatty acids, or C12-C14 fatty acids, or C16 to C18 fatty acids. Preferably the adsorbent is activated charcoal, and, most preferably the adsorbent is an acidified activated charcoal. Activated carbon and acidified activated carbon may be used in combination.

Embodiments of the invention include a method of processing a crude fatty acid stream comprising short chain fatty acids and impurities including coloring components. The method comprises mixing the crude fatty acid stream with 0.05 to 2.0 wt. % of activated carbon or acidified activated carbon (weight percentage based on the weight of the crude fatty acid stream for a predetermined duration to produce a fatty acid product stream comprising short chain fatty acids and an amount of coloring components that is less than the amount of coloring components in the crude fatty acid stream. In embodiments, activated carbon and acidified activated carbon are used in combination.

In embodiments, the acidified activated charcoal may be prepared by mixing activated charcoal with an aqueous phosphoric acid solution. Preferably the aqueous phosphoric acid solution a 1 to 40 wt. % phosphoric acid solution, more preferably from 1 to 20 wt. % phosphoric acid solution, or a 20 wt. % phosphoric acid solution, or preferably a 10 wt. % phosphoric acid aqueous solution at from 50 to 120° C., more preferably at 100° C. for from 2 hours to about 10 hours or even more in order to activate the surface of the activated carbon or of the and yield phosphoric acid treated activated carbon. The phosphoric acid treated activated carbon is then filtered and washed with distilled water until a pH of 4 to 5 is attained. pH was measured by boiling 100 ml of distilled water in a flask containing 0.1 g acidified activated carbon for 5 minutes. The pH was measured with an electronic pH meter after the solution was cooled to room temperature. The pH adjusted activated carbon is then dried to a moisture content of from 1 to 2 wt. % water to yield the acidified activated carbon which is used to treat the fatty acids.

Low chain fatty acids (identified as C8 to C10 fatty acids herein) treated with activated carbon and/or acidified activated carbon according to the present invention are heat stable and are not colored or only slightly colored, resulting in a product that may render traditional steps of distillation or other additional purification steps unnecessary. This reduces capital expenditures, reduced processing time, reduced processing steps, and other advantages compared to currently existing processes.

Embodiments of the invention include a method of processing a crude fatty acid stream comprising short chain fatty acids and impurities including coloring components. The method comprises mixing the crude fatty acid stream with 0.05 to 2.0 wt. % of activated carbon or acidified activated carbon, or both, (weight percentage based on the weight of the crude fatty acid stream), preferably an acidified activated carbon, at a temperature in a range of 80 to 120° C. for 1 minute to 10 hours, preferably from 1 to 2 hours, or more preferably from 30 to 60 minutes, to produce a fatty acid product stream comprising short chain fatty acids and an amount of coloring components that is less than the amount of coloring components in the crude fatty acid stream. The activated carbon, which is preferably acidified activated carbon, has a surface area with an Iodine number in a range of 1000 to 2000 mg/g.

The following includes definitions of various terms and phrases used throughout this specification.

The terms “about” or “approximately” are defined as being close to as understood by one of ordinary skill in the art. In one non-limiting embodiment the terms are defined to be within 10%, for example, within 5%, within 1%, and within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic diagram of a system of processing a crude fatty acid stream, according to embodiments of the invention; and

FIG. 2 shows a schematic flowchart of a method of processing a crude fatty acid stream, according to embodiments of the invention.

### DETAILED DESCRIPTION OF THE INVENTION

Currently, fatty acids used in chemical production are generally produced and purified from a crude fatty acid stream comprising short chain fatty acids and impurities. The conventional methods generally include hydrogenating the unsaturated and/or unstable fatty acids in the crude fatty acid stream and then separating the impurities from the fatty acids via distillation. Thus, the operating cost is relatively high due to high energy cost and high cost for hydrogen. Additionally, the capital expenditure for the conventional methods are relatively high due to multiple units used for the process. The present invention provides a solution to at least some of these problems. The solution is premised on a method of processing a crude fatty acid stream that comprises short chain fatty acids and impurities. The method of the present invention includes mixing the crude fatty acids stream, preferably comprising C8 to C10 fatty acids, with an adsorbent, preferably activated carbon or more preferably acidified activated carbon, for a predetermined duration to produce a fatty acid product stream comprising a reduced amount of impurities. This can be beneficial for at least reducing the energy consumption and eliminating the cost of hydrogen, resulting in lower production cost for purified fatty acids. Furthermore, the disclosed method does not require hydrogenation units and distillation columns, resulting in reduced capital expenditure. When acidified activated carbon is used, the fatty acids treated therewith may result in improved heat stability and/or improved color qualities compared to fatty acids treated by other methods known in the art, including treatment with non-acidified activated carbon.

These and other non-limiting aspects of the present invention are discussed in further detail in the following sections.

### A. System for Processing Crude Fatty Acid Stream

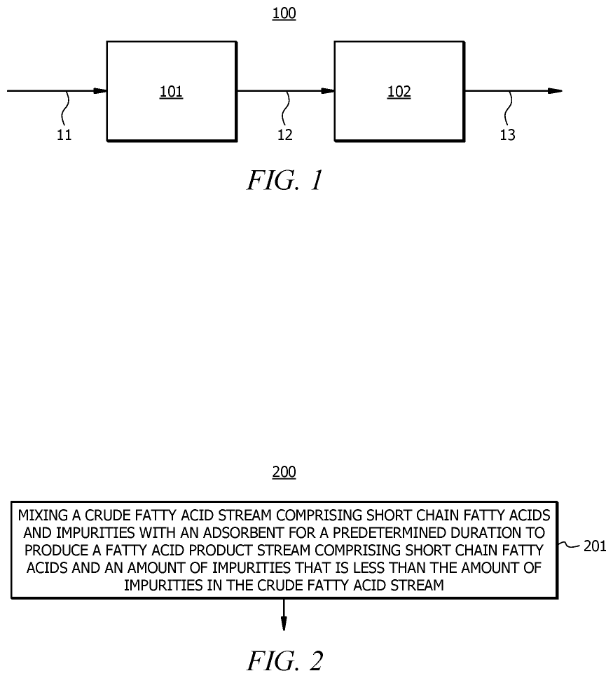

In embodiments of the invention, the system for processing a crude fatty acid stream is capable of reducing the energy cost, the material cost (hydrogen), and/or capital expenditure compared to conventional systems for purifying crude fatty acid streams. With reference to FIG. 1, a schematic diagram is shown for system 100, which is used for processing a crude fatty acid stream to produce a fatty acid product stream.

According to embodiments of the invention, system 100 includes splitting unit 101 configured to convert fat and/or oil of feed stream 11 to produce crude fatty acid stream 12. In embodiments of the invention, splitting unit 101 can include a pressure based hydrolysis unit, and/or an enzyme based hydrolysis unit. In embodiments of the invention, feed stream 11 can include natural oils, natural fats, and/or other fatty materials. For example, feed stream 11 can include kernel oil and/or coconut oil. Crude fatty acid stream 12 can include short chain free fatty acids and impurities. The short chain free fatty acids can include C₆ to C₁₄ fatty acids comprising one or more C₆ fatty acids, one or more C₇ fatty acids, one or more Ca fatty acids, one or more Co fatty acids, one or more C₁₀ fatty acids, one or more Cu fatty acids, one or more C₁₂ fatty acids, one or more C₁₃ fatty acids, one or more C₁₄ fatty acids, or combinations thereof. In embodiments of the invention, the short fatty acids can include C₈ to C₁₀ fatty acids comprising one or more C₈ fatty acids, one or more C₉ fatty acids, one or more C₁₀ fatty acids, or combinations thereof. Exemplary impurities can include incompletely split glycerides (including monoglycerides and/or diglycerides), coloring components, compounds including sterols, phosphatides. Exemplary coloring components can include quiniodoline, amines, nitriles, metal complexes, and combinations thereof.

In embodiments of the invention, splitting unit 101 includes a pressure hydrolysis unit and crude fatty acid stream 12 comprises 95 to 99 wt. % free fatty acids and all ranges and values there between including ranges of 95 to 95.5 wt. %, 95.5 to 96 wt. %, 96 to 96.5 wt. %, 96.5 to 97 wt. %, 97 to 97.5 wt. %, 97.5 to 98 wt. %, 98 to 98.5 wt. %, and 98.5 to 99 wt. %. Crude fatty acid stream 12 can include 0.5 to 5 wt. % impurities.

According to embodiments of the invention, an outlet of splitting unit 101 is in fluid communication with adsorption unit 102 such that crude fatty acid stream 12 flows from splitting unit 101 to adsorption unit 102. In embodiments of the invention, adsorption unit 102 is configured to adsorb at least some of the impurities from crude fatty acid stream 12 to produce product stream 13 comprising short chain fatty acids and an amount of the impurities that is less than the amount of impurities in crude fatty acid stream 12.

In embodiments of the invention, adsorption unit 102 is configured to mix an adsorbent with crude fatty acid stream 12 under processing conditions sufficient to adsorb at least some impurities from crude fatty acid stream 12 to produce product stream 13. The adsorbent, in embodiments of the invention, includes activated carbon and acidified activated carbon. The activated carbon and acidified activated carbon can have a surface area with an Iodine number in a range of 1000 to 2000 mg/g, for example 1500 to 1700 mg/g and all ranges and values there between including ranges of 1500 to 1520 mg/g, 1520 to 1540 mg/g, 1540 to 1560 mg/g, 1560 to 1580 mg/g, 1580 to 1600 mg/g, 1600 to 1620 mg/g, 1620 to 1640 mg/g, 1640 to 1660 mg/g, 1660 to 1680 mg/g, and 1680 to 1700 mg/g. In embodiments of the invention, the adsorbent, e.g., activated carbon or acidified activated carbon, is further configured to remove oxidative components from crude fatty acid stream 12.

The pH of the acidified activated carbon may range from 2.0 to 4.0, preferably from 2.5 to 3.5, more preferably from 3.0 to 4.0. The process for measuring pH is described above.

### B. Method of Preparing Acidified Activated Carbon

A method of preparing acidified activated carbon is also provided. The acidified activated carbon can be prepared by contacting activated carbon with an aqueous solution comprising water and an acid to provide an acid treated activated carbon. The strength of the aqueous solution may range from 1 wt. % to 40 wt. % acid, preferably 5 to 20 wt. %, and more preferably 10 to 20 wt. % acid., and any ranges or values in between including the endpoints.

The contact time of the activated carbon may range from 1 minute to 10 hours, preferably from 0.5 hour to 5 hours, and more preferably from 0.5 to 2 hours, and any ranges or values in between including the endpoints.

The activated carbon used to prepare the acidified activated carbon may have the properties mentioned above, including a surface area with an Iodine number in a range of 1000 to 2000 mg/g, for example 1500 to 1700 mg/g and all ranges and values there between including ranges of 1500 to 1520 mg/g, 1520 to 1540 mg/g, 1540 to 1560 mg/g, 1560 to 1580 mg/g, 1580 to 1600 mg/g, 1600 to 1620 mg/g, 1620 to 1640 mg/g, 1640 to 1660 mg/g, 1660 to 1680 mg/g, and 1680 to 1700 mg/g.

Preferably, the water in the aqueous solution is deionized water.

The acid used to acidify the activated carbon may be hydrochloric acid, nitric acid, sulfuric acid, hydrobromic acid, hydroiodic acid, perchloric acid, chloric acid and phosphoric acid, preferably phosphoric acid; or any combination thereof.

Washing of the acid treated activated carbon with water is accomplished by washing one or more times with the water until a pH of from 4 to 5 is obtained. The washed acid treated activated carbon is then dried to yield acidified activated carbon. Drying may be accomplished by placing the acid treated water in ambient air until dried, or by placing in an oven at from above room temperature to 150° C., preferably from 10° C. to 150° C., more preferably from 120° C. to 130° C., and any ranges or values in between including the endpoints. Preferably, the drying occurs until less than 5 wt % water remains, more preferably from 0.1 to 2 wt % water remains, and more preferably from 0.01 to 1 wt % water remains in the acidified activated carbon

### C. Method of Processing Crude Fatty Acids

Methods of processing crude fatty acids have been discovered. As shown in FIG. 2, embodiments of the invention include method 200 for processing crude fatty acid, with reduced production cost and reduced capital expenditure compared to conventional methods. Method 200 may be implemented by system 100, as shown in FIG. 1 and described above.

According to embodiments of the invention, as shown in block 201, method 200 includes mixing crude fatty acid stream 12 with the adsorbent in adsorption unit 102 for a predetermined duration to produce product stream 13. In embodiments of the invention, crude fatty acid stream 12 is obtained from splitting feed stream 11 that comprises natural oils, natural fats, and/or other fatty materials. In embodiments of the invention, feed stream 11 can comprise palm kernel oil and/or coconut oil. The splitting of feed stream 11 can be conducted in splitting unit 101 under splitting conditions including a splitting temperature of 180 to 250° C., and a splitting pressure of 2 to 5 bar. In embodiments of the invention, crude fatty acid stream 12 comprises 95 to 99 wt. % free fatty acids, and 0.5 to 5 wt. % of the impurities. Exemplary impurities can include incompletely split glycerides (including monoglycerides and/or diglycerides), coloring components, compounds including sterols, phosphatides. Exemplary coloring components can include quiniodoline, amines, nitriles, metal complexes, and combinations thereof.

According to embodiments of the invention, the adsorbent includes activated carbon, and, at block 201, the activated carbon or acidified activated carbon is mixed with crude fatty acid stream 12 at an activated carbon concentration of about 0.05 to 2.0 wt. % (based on weight of crude fatty acid stream 12), for example 0.5 to 1.0 wt. % and all ranges and values there between including ranges of 0.5 to 0.6 wt. %, 0.6 to 0.7 wt. %, 0.7 to 0.8 wt. %, 0.8 to 0.9 wt. %, and 0.9 to 1.0 wt. %. In embodiments of the invention, the activated carbon has a surface area with an Iodine number in a range of 1000 to 2000 mg/g, for example 1500 to 1700 mg/g.

According to embodiments of the invention, product stream 13 comprises 95 to 98 wt. % short chain fatty acids and all ranges and values there between. Product stream 13 can include an amount of impurities that is less than the amount of impurities in crude fatty acid stream 12. In embodiments of the invention, product stream 13 can comprise 0.1 to 0.5 wt. % of the impurities and all ranges and values there between. Product stream 13 can include an amount of coloring components that is less than the amount of coloring components in crude fatty acid stream 12. In embodiments of the invention, product stream 13 comprises less than 0.05 wt. % coloring components and crude fatty acid stream 12 comprises 0.2 to 0.05 wt. % coloring components. Fatty acid product stream 13 may comprise less than 5 ppm metal complexes, preferably from 0.001 to 5 ppm metal complexes, and preferably no metal complexes. Typically, these metal complexes may be found in the crude fatty acid stream and are a byproduct of metals that may contained in catalysts used to make the crude fatty acid stream, or may result from leaching or dissolution of the equipment used during processing.

According to embodiments of the invention, at block 201, the processing conditions include a processing temperature of 80 to 120° C. and all ranges and values there between including ranges of 80 to 85° C., 85 to 90° C., 90 to 95° C., 95 to 100° C., 100 to 105° C., 105 to 110° C., 110 to 115° C., and 115 to 120° C. In embodiments of the invention, the activated carbon or acidified activated carbon is mixed with crude fatty acid stream 12 at an initial temperature of 20 to 30° C. and the temperature of the mixture is gradually increased to the processing temperature. The processing conditions at block 201 can include a predetermined duration of 30 to 60 minutes and all ranges and values there between including ranges of 30 to 33 minutes, 33 to 36 minutes, 36 to 39 minutes, 39 to 42 minutes, 42 to 45 minutes, 45 to 48 minutes, 48 to 51 minutes, 51 to 54 minutes, 54 to 57 minutes, and 57 to 60 minutes.

According to embodiments of the invention, method 200 is configured to improve heat stability and/or oxidative stability of fatty acids of crude fatty acid stream 12. In embodiments of the invention, the heat stability and/or oxidative stability of fatty acids of crude fatty acid stream 12 is improved via removal of oxidative components there from. Exemplary oxidative components include amino-components, polyunsaturated compounds, nitriles, natural colorants, and combinations thereof.

Although embodiments of the present invention have been described with reference to blocks of FIG. 2 should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2.

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown.

As part of the disclosure of the present invention, specific examples are included below. The examples are for illustrative purposes only and are not intended to limit the invention. Those of ordinary skill in the art will readily recognize parameters that can be changed or modified to yield essentially the same results.

### Example 1

(Evaluation of Effects of Activated Carbon on Crude C₈/C₁₀ Fatty Acids)

1 kg samples from a crude C₈/C₁₀ fatty acid stream were independently mixed with 0.6 wt. % of three different samples of activated carbon:

Sample 1) Activated carbon having a surface area of 1700 m² when measured by the BET method, an Iodine number of 1700 and a particle size range of from 5 to 100 μm, and having a pH near neutral (pH 7-7.5);

Sample 2) Activated carbon having a surface area of 1100 m² when measured by the BET method, an Iodine number of 950 and a particle size range of from 0.42 mm to 2.00 mm, and having a pH of from 7 to 8; and

Sample 3) Activated carbon having a surface area of 1050 m² when measured by the BET method, an Iodine number of 900 and a particle size range of from 0.42 mm to 2.00 mm, and having a pH of from 7 to 8.

The mixtures were kept at 100° C. for 45 minutes to produce a treated C₈/C₁₀ fatty acid sample. The compositions of crude C₈/C₁₀ fatty acid samples and the treated C₈/C₁₀ fatty acid streams (treated by 0.6 wt. % activated carbon based on the weight of the crude C₈/C₁₀ fatty acid stream) are shown in Table 1. The color values (Lovibond) of the crude C₈/C₁₀ fatty acid sample, and the treated C₈/C₁₀ fatty acid sample by 0.6 wt. % activated carbon are shown in Table 2. The results of heat stability test (AOCS Td 3a-64, Official Methods and Recommended Practices—Color After Heating) are shown in Table 3. The results show that after activated carbon treatment, the heat stability and the color value of the treated fatty acid sample were improved compared to the crude fatty acid sample. Therefore, activated carbon treatment is efficient for the short chain fatty acids compared to the long chain fatty acids.

TABLE 1
The composition of the C₈/C₁₀ fatty acid sample before and
after treatment with the activated carbon of Sample 1
obtained via gas chromatography (GC) analysis. Efficacy
of impurities of less than 50 ppm for the color heat
stability test is beyond the GC detection limits.

| | | Treated C₈/C₁₀ |
|---|---|---|
| | | fatty acid |
| | Crude | (0.6% Activated |
| Components | C₈/C₁₀ | carbon (neutral)) |
| C₄ Acid | <0.01 | <0.01 |
| C₆ Acid | 0.16 | 0.114 |
| Nonanone | <0.01 | <0.01 |
| C₇ Acid | 0.01 | 0.06 |
| Benzoic acid | 0.07 | 0.091 |
| C₈ Acid | 52.17 | 52.1 |
| 2-Undecanone | 0.197 | 0.197 |
| C₉ Acid | 0.28 | 0.1 |
| C₁₀ Acid | 47.63 | 47.52 |
| Tridecanone | 0.02 | 0.027 |
| Dodecanoic acid | 0.47 | 0.04 |
| methylester | | |
| C₁₁ Acid | 0.14 | 0.04 |
| Dodecanoic acid | 0.04 | 0.04 |
| ethylester | | |
| C₁₂- Acid | 0.01 | <0.01 |
| C₁₆- Acid | 0.04 | 0.04 |
| Oleic acid | 0.02 | 0..02 |
| C₁₈- Acid | <0.01 | 0.03 |
| C₂₀- Acid | <0.01 | <0.01 |
| C₂₄- Acid | <0.01 | <0.01 |
| Quinone derivative | <0.01 | <0.01 |
| Amino components | <25 ppm | <25 ppm |

*Organic impurities were identified using the gas chromatography-Mass spectrometry (GC/MS) method. Lower level (<25 ppm) of amino impurities also detected in the crude fatty acid composition.

TABLE 2
Results for color value (Lovibond) comparisons (at
0.6 wt. % activated carbon/kg fatty acid sample)

| | | Color value |
|---|---|---|
| | Activated Carbon Sample | (Lovibond) |
| 1 | C₈/C₁₀ fatty acid sample (as such) | 2.4 Y/0.4 R |
| 2 | Activated carbon Sample 1 | 2.8 Y/0.4 R |
| 3 | Activated carbon Sample 2 | 2.4 Y/0.5 R |
| 4 | Activated carbon Sample 3 | 2.8 Y/0.4 R |

TABLE 3
Results for heat stability test (AOCS Td 3a-64)

| | | Color value | Color value |
|---|---|---|---|
| | | (Lovibond 5-¼) | (Lovibond 5-¼) |
| | | Before Heat | After Heat |
| | Before Heat stability | stability | stability Test |
| 1 | C₈/C₁₀ fatty acid (as such) | 2.4Y/0.4R | 30 Y/2.8 R |
| 2 | Activated carbon Sample 1 | 2.8 Y/0.4 R | 18 Y/1.8 R |
| 3 | Activated carbon Sample 2 | 2.4 Y/0.5 R | 17 Y/1.8 R |
| 4 | Activated carbon Sample 3 | 2.4 Y/0.5 R | 17 Y/1.8 R |

The data show that heat stability of the C₈/C₁₀ fatty acid sample was improved with activated carbon treatment.

Heat stability is correlated with the color stability of C9/C10 fatty acid. Fatty acid changes in color when it is exposed to higher temperature (Test: AOCS Td 3a-64), due to the degradation of low thermally stable compounds. The presence of amino compounds, unsaturated compounds, and other natural colorants degrade at higher temperature and cause shift in reflected wavelengths of light (Bathochromic shift). Often, the color shift is so prominent, the naked eye is clearly able to identify it. The current invention is focused on using a suitable adsorbent, which can eliminate the thermally low stable molecules and improve the heat stability.

### Example 2

### (Preparation of Acidified Activated Carbon)

Acidified activated carbon was prepared as follows:

10 grams of an activated carbon powder having an average particle size range of from 10 to 90 microns when measured with a Malvern Mastersizer 2000 laser diffraction particle size analyzer was mixed with 100 grams of a 20 wt. % phosphoric acid aqueous solution at a temperature of 90-100° C. for 2 hrs. The suspension was then filtered with a filter that only retained particles larger than 5 microns, and washed with distilled water until to obtain a pH of about 3.5 to 4.0. The phosphoric acid treated activated carbon was then dried at 120-130° C. for 2 to 4 hours to obtain the acidified activated carbon. A 0.1 g sample of the dried product was then mixed with 100 grams of water to again test the pH, which was about 4.0.

### Example 3

(Evaluation of Effects of Acidified Activated Carbon on Crude C₈/C₁₀ Fatty Acids)

A 1 kg crude C₈/C₁₀ fatty acid sample was mixed with acidified activated carbon prepared according to Example 2. The acidified activated carbon has a surface area of 1600 to 1700 m² when measured according to the BET method, and an Iodine number of 1700. The mixture was kept at 100° C. for 45 minutes to produce a treated C₈/C₁₀ fatty acid stream. The compositions of crude C₈/C₁₀ fatty acid stream and the treated C₈/C₁₀ fatty acid stream (treated by 0.5 wt. % activated carbon based on the weight of the crude C₈/C₁₀ fatty acid stream) are shown in Table 4. The color values (Lovibond) of the crude C₈/C₁₀ fatty acid stream, treated C₈/C₁₀ fatty acid stream by 0.5 wt. % acidified activated carbon, treated C₈/C₁₀ fatty acid stream by 0.6 wt. % acidified activated carbon, and treated C₈/C₁₀ fatty acid stream by 1.0 wt. % acidified activated carbon are shown in Table %. The results of heat stability test (AOCS Td 3a-64, Official Methods and Recommended Practices—Color After Heating) are shown in Table 3. The results show that after acidified activated carbon treatment, the heat stability and the color value of the treated fatty acid stream were improved compared to the crude fatty acid stream. Therefore, acidified activated carbon treatment is efficient for the short chain fatty acids compared to the long chain fatty acids.

TABLE 4
The composition of the C₈/C₁₀ fatty acid before and after treatment
with acidified activated carbon obtained via gas chromatography
(GC) analysis. Efficacy of impurities of less than 50 ppm for the
color heat stability test is beyond the GC detection limits.

| | | Treated C₈/C₁₀ |
|---|---|---|
| | | fatty acid |
| | | (0.5% acidified |
| Components | Crude C₈/C₁₀ | activated carbon) |
| C₄ Acid | <0.01 | <0.01 |
| C₆ Acid | 0.16 | 0.17 |
| Nonanone | <0.01 | <0.01 |
| C₇ Acid | 0.01 | 0.06 |
| Benzoic acid | 0.07 | 0.06 |
| C₈ Acid | 52.17 | 52.78 |
| 2-Undecanone | 0.03 | 0.02 |
| C₉ Acid | 0.28 | 0.1 |
| C₁₀ Acid | 46.63 | 46.63 |
| Tridecanone | 0.02 | 0.01 |
| Dodecanoic acid | 0.02 | 0.02 |
| methylester | | |
| C₁₁ Acid | 0.14 | 0.04 |
| Dodecanoic acid | 0.04 | 0.04 |
| ethylester | | |
| C₁₂- Acid | 0.01 | <0.01 |
| C₁₆- Acid | 0.04 | 0.04 |
| Oleic acid | 0.02 | 0.02 |
| C₁₈- Acid | 0.04 | 0.03 |
| C₂₀- Acid | <0.01 | Not detected (n.d.) |
| C₂₄- Acid | <0.01 | n.d. |
| Quinone derivative | <0.01 | n.d. |
| Amino components | <25 ppm | n.d. |

*Organic impurities were identified using the gas chromatography-Mass spectrometry (GC/MS) method. Lower level (<25 ppm) of amino impurities also detected in the crude fatty acid composition. Major color imparting impurities (Quinones, amino & unsaturated long chain fatty acids) were eliminated effectively during the acidified activated carbon treatment.

TABLE 5
Results for color value (Lovibond) comparisons

| | | Color value |
|---|---|---|
| | Treatment | (Lovibond) |
| 1 | C₈/C₁₀ fatty acid (as such) | 2.4 Y/0.4 R |
| 2 | Acidified activated carbon | 1.0 Y/0.1 R |
| | 0.5% C₈/C₁₀ fatty acid | |
| 3 | Acidified activated carbon | 0.8 Y/0.1 R |
| | 0.6% C₈/C₁₀ fatty acid | |
| 4 | Acidified activated carbon | 0.8 Y/0.1 R |
| | 1.0% C₈/C₁₀ fatty acid | |

TABLE 6
Results for heat stability test for Treatment 3 (AOCS Td 3a-64)

| | | Color value | Color value |
|---|---|---|---|
| | | (Lovibond 5-_{1/4}) | (Lovibond 5-_{1/4}) |
| | | Before Heat | After Heat |
| | Before Heat stability | stability | stability |
| 1 | C₈/C₁₀ fatty acid (as such) | 2.4Y/0.4R | 30 Y/2.8 R |
| 2 | Acidified activated carbon | 0.8 Y/0.1 R | 3.0Y/0.3 R |
| | 0.5 wt. % C₈/C₁₀ fatty acid | | |
| 3 | Acidified activated carbon | 0.8 Y/0.1 R | 3.0Y/0.3 R |
| | 0.6 wt. % C₈/C₁₀ fatty acid | | |
| 4 | Acidified activated carbon | 0.8 Y/0.1 R | 3.8 Y/0.6R |
| | 1 wt. % C₈/C₁₀ fatty acid | | |

Heat stability is correlated with the color stability of Co/Co fatty acid. Fatty acid changes in color when it is exposed to higher temperature (Test: AOCS Td 3a-64), due to the degradation of low thermally stable compounds. The presence of amino compounds, unsaturated compounds, and other natural colorants degrade at higher temperature and cause shift in reflected wavelengths of light (Bathochromic shift). Often, the color shift is so prominent, the naked eye is clearly able to identify it. The current invention is focused on using the suitable adsorbent, which can eliminate the thermally low stable molecules and improve the heat stability.

### Example 4

Another experiment was performed in accordance with and Example 3, using 0.6 wt. % of the acidified active carbon, except that the sample of the C₈-C₁₀ sample had the following properties:

TABLE 7

| Test | Unit | Test Method | Value |
|---|---|---|---|
| Acid Number | mg KOH/g | AOCS Te 1a-64 | 358.06 |
| Saponification Value | mg KOH/g | AOCS Tl 1a-64 | 358.29 |
| Moisture | % | AOCS Tb 2-64 | 0.027 |
| Iodine Value | G l2/100 g | AOCS Tg 1a-64 | 0.26 |
| Titer | C | AOCS Tr 1a-64 | |
| Colour (Lovibond) | Lovibond/Apha | AOCS Cc 13e 92 | .05 R, 2.6 Y |
| Unsaponifiable Matter | % | AOCS Tk 1a-64 | 0.2 |
| Heat Stability (2 hours | Lovibond/Apha | AOCS Td 3a 64 | 17 Y/1.8 R |
| 205° C., N2) | | | |

The results are shown below in Table 8:

TABLE 8

| PARAMETER | UNIT | RANGE | METHOD | VALUE |
|---|---|---|---|---|
| Acid Number | mg KOH/g | 354-367 | AOCS Te | 358.06 |
| | | | 1a-64 | |
| Saponification | mg KOH/g | 355-368 | AOCS Tl | 358.29 |
| Value | | | 1a-64 | |
| Moisture | % | ≤0.2 | AOCS Tb | 0.027 |
| | | | 2-64 | |
| Iodine Value | g I2/100 g | ≤0.5 | AOCS Tg | 0.26 |
| | | | 1a-64 | |
| Colour | Lovibond/ | ≤0.5R | AOCS Cc | 0.2 R, 1.10 Y |
| (Lovibond) | Apha | 2.0 Y | 13e-92 | |
| Unsaponifiable | % | ≤0.5 | AOCS Tk | 0.1 |
| Matter | | | 1a-64 | |
| Heat Stability | Lovibond/ | ≤25 | AOCS Td | 0.4 R, 2.5 Y |
| (2 hours | Apha | (10R + Y) | 3a-64 | |
| 205° C., N2) | | | | |

These results show a vastly improved color profile which is indicative of a improved heat stability.

Heat stability is correlated with the color stability of C₉/C₁₀ fatty acid. Fatty acid changes in color when it is exposed to higher temperature (Test: AOCS Td 3a-64), due to the degradation of low thermally stable compounds. The presence of amino compounds, unsaturated compounds, and other natural colorants degrade at higher temperature and cause shift in reflected wavelengths of light (Bathochromic shift). Often, the color shift is so prominent, the naked eye is clearly able to identify it. The current invention is focused on using the suitable adsorbent, which can eliminate the thermally low stable molecules and improve the heat stability.

In the context of the present invention, at least the following embodiments are described. Embodiment 1 is a method of processing a crude fatty acid stream containing short chain fatty acids and impurities. The method includes mixing the crude fatty acid stream with an adsorbent for a predetermined duration to produce a fatty acid product stream containing short chain fatty acids and an amount of impurities that is less than the amount of impurities in the crude fatty acid stream. Embodiment 2 is the method of embodiment 1, wherein the adsorbent contains activated carbon. Embodiment 3 is the method of embodiment 2, wherein the crude fatty acid stream is mixed with 0.05 to 2.0 wt. % activated carbon. Embodiment 4 is the method of any of embodiments 2 and 3, wherein the activated carbon has a surface area with an Iodine number in a range of 1000 to 2000 mg/g. Embodiment 5 is the method of embodiment 4, wherein the activated carbon has a surface area with an Iodine number in a range of 1500 to 1700 mg/g. Embodiment 6 is the method of any of embodiments 1 to 5, wherein the short chain fatty acids include C₆ fatty acids to C₁₄ fatty acids. Embodiment 7 is the method of embodiment 6, wherein the short chain fatty acids include C₈ fatty acids to C₁₀ fatty acids. Embodiment 8 is the method of any of embodiments 1 to 7, wherein the impurities include coloring components, glycerides, sterols, phosphatides, or combinations thereof. Embodiment 9 is the method of embodiment 8, wherein the coloring components include quiniodoline, amines, nitriles, metal complexes, or combinations thereof. Embodiment 10 is the method of any of embodiments 1 to 9, wherein the crude fatty acid stream is derived from palm kernel oil and/or coconut oil. Embodiment 11 is the method of any of embodiments 1 to 10, wherein the crude fatty acid stream contains 95 to 99 wt. % free fatty acids. Embodiment 12 is the method of any of embodiments 1 to 11, wherein the fatty acid product stream contains less than 5 ppm metal complexes. Embodiment 13 is the method of any of embodiments 1 to 12, wherein the method is configured to improve heat stability and/or oxidative stability of the crude fatty acid stream via removal of oxidative components. Embodiment 14 is the method of embodiment 13, wherein the heat stability of the crude fatty acid stream after removal of oxidative components for 2 hours at 205° C. under nitrogen AOCS Td 3a-64 is less than 3 units. Embodiment 15 is the method of any of embodiments 13 and 14, wherein the oxidative components include quinone, amines, metal complexes, amino-components, or combinations thereof. Embodiment 16 is the method of any of embodiments 1 to 15, wherein mixing step is conducted at a temperature in a range of 80 to 120° C. Embodiment 17 is the method of any of embodiments 1 to 16, wherein the predetermined duration is in a range of 30 to 60 minutes. Embodiment 18 is the method of any of embodiments 1 to 17, wherein the adsorbent comprises acidified activated carbon. Embodiment 19 is a method of preparing acidified activated carbon comprising the steps of contacting activated carbon with an aqueous solution comprising water and an acid to provide an acid treated activated carbon, and washing the acid treated activated carbon with water until a pH of from 4 to 5 is obtained, and drying the washed acid treated activated carbon to yield acidified activated carbon. Embodiment 20 is the method of embodiment 18, wherein the acidified carbon is prepared according to the method of embodiment 19. Embodiment 21 is the method of embodiments 19 or 20, wherein the acid is phosphoric acid. Embodiment 22 is the method of any of embodiments 19 to 21, wherein the contacting is conducted at a temperature of from 100° C. to 150° C. Embodiment 23 is the method of embodiment 18, wherein the crude fatty acid stream is mixed with 0.05 to 2.0 wt. % activated carbon. Embodiment 24 is the method of any of embodiments 18 and 19, wherein the activated carbon has a surface area with an Iodine number in a range of 1000 to 2000 mg/g. Embodiment 25 is the method of embodiment 24, wherein the activated carbon has a surface area with an Iodine number in a range of 1500 to 1700 mg/g. Embodiment 26 is the method of any of embodiments 18 and 23-25, wherein the short chain fatty acids include C₆ fatty acids to C₁₄ fatty acids. Embodiment 27 is the method of embodiment 26, wherein the short chain fatty acids include C₈ fatty acids to C₁₀ fatty acids. Embodiment 28 is the method of any of embodiments 18 to 21 and 24-27, wherein the impurities include coloring components, glycerides, sterols, phosphatides, or combinations thereof. Embodiment 29 is the method of embodiment 28, wherein the coloring components include quiniodoline, amines, nitriles, metal complexes, or combinations thereof. Embodiment 30 is the method of any of embodiments 18 and 23 to 29, wherein the crude fatty acid stream is derived from palm kernel oil and/or coconut oil. Embodiment 31 is the method of any of embodiments 18 and 23 to 30, wherein the crude fatty acid stream comprises 95 to 99 wt. % free fatty acids. Embodiment 32 is the method of any of embodiments 18 and 23 to 31, wherein the fatty acid product stream comprises less than 5 ppm metal complexes. Embodiment 33 is the method of any of embodiments 18 and 23 to 32, wherein the method is configured to improve heat stability and/or oxidative stability of the crude fatty acid stream via removal of oxidative components. Embodiment 34 is the method of embodiment 33, wherein the heat stability of the crude fatty acid stream after removal of oxidative components for 2 hours at 205° C. under nitrogen AOCS Td 3a-64 is less than 3 units. Embodiment 35 is the method of any of embodiments 33 and 34, wherein the oxidative components include quinone, amines, metal complexes, amino-components, or combinations thereof. Embodiment 36 is the method of any of embodiments 18 and 23-36, wherein mixing step is conducted at a temperature in a range of 80 to 120° C. Embodiment 37 is the method of any of Embodiments 1 and 23 to 36, wherein the predetermined duration is in a range of 30 to 60 minutes. Embodiment 38 is the method of any of embodiments 1 to 17, wherein the adsorbent comprises activated carbon and acidified activated carbon. Embodiment 39 is a method of processing a crude fatty acid stream comprising short chain fatty acids and impurities, the method comprising mixing the crude fatty acid stream with an adsorbent for 1 minute to 10 hours to produce a fatty acid product stream comprising short chain fatty acids and an amount of impurities that is less than the amount of impurities in the crude fatty acid stream.

All embodiments described above and herein can be combined in any manner unless expressly excluded.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of processing a crude fatty acid stream comprising short chain fatty acids and impurities, the method comprising:
mixing the crude fatty acid stream with an adsorbent for 1 minute to 10 hours to produce a fatty acid product stream comprising short chain fatty acids and an amount of impurities that is less than the amount of impurities in the crude fatty acid stream.

2. The method of claim 1, wherein the adsorbent comprises activated carbon.

3. The method of claim 2, wherein the crude fatty acid stream is mixed with 0.05 to 2.0 wt. % activated carbon.

4. The method of claim 2, wherein the activated carbon has a surface area with an Iodine number in a range of 1000 to 2000 mg/g.

5. The method of claim 4, wherein the activated carbon has a surface area with an Iodine number in a range of 1500 to 1700 mg/g.

6. The method of claim 1, wherein the short chain fatty acids include C₆ fatty acids to C₁₄ fatty acids.

7. The method of claim 6, wherein the short chain fatty acids include C₈ fatty acids to C₁₀ fatty acids.

8. The method of claim 1, wherein the impurities include coloring components, glycerides, sterols, phosphatides, or combinations thereof.

9. The method of claim 8, wherein the coloring components include quiniodoline, amines, nitriles, metal complexes, or combinations thereof.

10. The method of claim 1, wherein the crude fatty acid stream is derived from palm kernel oil and/or coconut oil.

11. The method of claim 1, wherein the crude fatty acid stream comprises 95 to 99 wt. % free fatty acids.

12. The method of claim 1, wherein the fatty acid product stream comprises less than 5 ppm metal complexes.

13. The method of claim 1, wherein the method is configured to improve heat stability and/or oxidative stability of the crude fatty acid stream via removal of oxidative components.

14. The method of claim 13, wherein the heat stability of the crude fatty acid stream after removal of oxidative components for 2 hours at 205° C. under nitrogen AOCS Td 3a-64 is less than 3 units.

15. The method of claim 13, wherein the oxidative components include quinone, amines, metal complexes, amino-components, or combinations thereof.

16. The method of claim 1, wherein mixing step is conducted at a temperature in a range of 80 to 120° C.

17. The method of claim 1, wherein the mixing is conducted for a time period in a range of 30 to 60 minutes.

18. The method of claim 1, wherein the adsorbent comprises acidified activated carbon.

19. A method of preparing acidified activated carbon comprising the steps of contacting activated carbon with an aqueous solution comprising water and an acid to provide an acid treated activated carbon, and washing the acid treated activated carbon with water until a pH of from 4 to 5 is obtained, and drying the washed acid treated activated carbon to yield acidified activated carbon.

20. (canceled)

21. The method of claim 19, wherein the acid is phosphoric acid.

22. The method of claim 19, wherein the contacting is conducted at a temperature of from 100° C. to 150° C.

23. (canceled)

24. The method of claim 19, wherein the activated carbon has a surface area with an Iodine number in a range of 1000 to 2000 mg/g.

25. The method of claim 24, wherein the activated carbon has a surface area with an Iodine number in a range of 1500 to 1700 mg/g.

26-37. (canceled)

38. The method of claim 1, wherein the adsorbent comprises activated carbon and acidified activated carbon.

39. The method of claim 18, wherein the pH of the acidified activated carbon is in a range from 2.0 to 4.0.
